(19) United States
(12) Patent Application Publication
(10) Pub. No.: US 2012/0259582 A1
(43) Pub. Date: Oct. 11, 2012

(54) Device And Method For Identifying Instruments

(76) Inventor: Oliver Gloger, Berlin (DE)

(21) Appl. No.: 13/440,441

(22) Filed: Apr. 5, 2012

(30) Foreign Application Priority Data
Apr. 5, 2011 (DE) 10 2011 016 663.7

(51) Int. Cl. G06F 15/00; G01N 5/00

(52) U.S. Cl. 702/173; 901/2

(57) ABSTRACT

The invention relates to a device for identifying instruments comprising at least one weight sensor, a data processing system, which has an interface, at least one database and an processing unit, and a visualization unit. Weight distribution data of instruments can be determined and compared by the device. This allows identifying individual instruments. The invention further relates to according methods for detecting a weight distribution of an individual instrument and for identifying an individual instrument, as well as to a method for assembling instrument sets.

### BACKGROUND OF THE INVENTION

The present invention relates to a device for identifying individual instruments. The present invention further relates to methods for detecting a weight distribution of an individual instrument and for identifying an individual instrument, as well as to a method for assembling instrument sets.

U.S. Pat. No. 7,180,014 B2 (in the following the '014 patent) describes a device for tracking instruments.

In said device, a set of medical instruments required for an operation is assembled by individual instruments being successively placed onto a weighing unit and the weight determined by the weighing unit being stored in the process for each instrument by means of a data processing system. For this purpose, the data processing system, via a visualization unit, here for example a monitor, provides information about which instrument is intended to be added next to the set. The addition of an instrument is detected by the change in total weight. If the set is complete, it can then be sterilized in a container provided for this purpose, a so-called instrument tray. Thus, it is then suitable for use in an operation. In order to check the completeness of the tray during and/or after the operation, verification weighings can be carried out.

Furthermore, the '014 patent presents a device in which different instruments are separately arranged in individual zones on a weighing table. Said zones are monitored by a camera or a light barrier to the effect of whether one of said instruments is grasped or put back by a surgeon or the auxiliary personnel, which can initially also be registered by means of the change in total weight (increase or decrease). If this is the case, on the basis of the zone identified by the camera or the light barriers and the change in weight, a data processing system registers which instrument was removed or added. The intention is thereby to be able to know, during and after the operation, which instrument is currently missing or whether the set is complete.

In the devices described in the '014 patent, the determination or identification of the respective instrument is always effected on the basis of total weight. Since, during the manufacture of instruments, small weight deviations among one another can always occur, these unknown deviations have to be taken into account during every weighing. However, this in turn has the effect that the entire system becomes more susceptible to the situation in which one type of instrument can be confused with another type of instrument if their weights are similar.

Although the separation—provided in the '014 patent—of the instruments into regions on a weighing table and the monitoring of said regions by a camera or light barriers are intended to counteract this source of error, they themselves also involve sources of error. This is because it is necessary for the instruments to be put down or picked up exactly in these zones. Just by picking them up or putting them down in the edge regions of the respective zones errors in identification can already easily occur.

With regard to the exact identification of individual instruments, the use of identifications directly on the instruments is described for example in U.S. Pat. No. 5,996,889 A. By way of example, direct inscriptions with letters and numbers or alternatively machine-readable bar codes or matrix codes are appropriate for this purpose. Both the exact individual instrument and the type of instrument can thereby be identified via these identifications.

A disadvantage of this method is that the corresponding identifications for each individual instrument have to be individually read and evaluated either manually or by using an electronic reader. This is associated with comparatively high expenditure of time and thus disadvantageous both before and, in particular, during an operation.

Furthermore, additional inscriptions or identifications applied on the instruments have the disadvantage that they fade or are washed away over time under the comparatively harsh conditions of conventional sterilization, particularly the high temperatures and the cleaning agents.

It is therefore an object of the present invention to provide a device and an associated method which makes it possible for different individual instruments to be rapidly and reliably distinguished and also identified, in order thus to enable a simplification and also automation in the production and provision of instrument sets, for example for use in operations.

### SUMMARY OF THE INVENTION

The object is achieved by a device for identifying individual instruments comprising: at least one weight sensor, being suitable for determining weight distributions of individual instruments, a visualization unit, and a data processing system, with an interface, at least one database and a processing unit, said data processing system being designed such that it can receive weight distribution data of at least one individual instrument from said at least one weight sensor via said interface, store said received weight distribution data in said database, compare said received and/or stored weight distribution data with already stored weight distribution data of instruments, and thereby identify said at least one individual instrument.

The term “weight distribution” is to be understood as a collection of data points with every individual data point comprising the coordinates of one of the contact points of the instrument with a measuring surface of the sensor and the forces executed at the contact point by the weight of that part of the instrument that rests on the contact point. These contact points are at least two points via which the body lies on said surface. The contact points may comprise at least one two-dimensional contact area. Such a two-dimensional contact area via which the body is in contact with said surface is theoretically composed of an infinite number of contact points. However, in the context of the present invention these points of such an area will be represented by a finite number of points for measuring said weights, the number of these points depends on the resolution of the weight sensor used for determining the singular weights.

Detecting the weight distribution of an individual instrument has the advantage over the simple weight as such that—depending on the type of instrument, its size and, consequently, its geometrical configuration and its weight—different weight distribution data are obtained. These data are thus object- or instrument-specific. These weight distribution data, which thus represent an object-specific weight impression or an object-specific weight distribution image of an instrument, can be detected, if appropriate processed and stored by the data processing system in a simple manner. As a result, different impressions or weight distribution images for the respective different instruments can be generated and stored in the database. They form the reference for the comparison with newly recognized weight distribution data of individual instruments which are intended to be identified. For this purpose, the newly detected data are compared with the stored reference data, which enables an exact identification of an individual instrument thus newly placed onto the at least one weight sensor. Consequently, it even becomes possible, for example, for two medical clamps, one having a straight end profile, the other being curved, which both have an identical total weight, to be distinguished from one another. This is not possible in the case of the devices known and described before. In general, the detection of weight distribution data by the at least one weight sensor will preferably be realized by the at least one weight sensor comprising a plurality of single sensors. These can be arranged in the shape of an array or in circular symmetry, for example. The individual instrument to be identified then covers or lies on at least two single sensors in order to achieve a detectable weight distribution.

Furthermore, by comparison with the devices mentioned before, the device according to the present invention even allows the identification of different individual instruments simultaneously, since a correspondingly designed weight sensor can record all at once a plurality of weight distribution images of instruments situated alongside one another on said sensor. Said images can then be separated by the data processing system or the associated processing unit into individual weight distribution images or the individual weight distribution data. From this possibility of identifying the individual weight distribution images from the overall weight distribution image it is furthermore possible to determine the exact position of the individual instruments on the weight sensor. This is advantageous especially when the intention is to automate the corresponding device for packing processes.

When mention is made of instruments hereinbefore and hereinafter, this is intended to relate to all types of instruments used e.g. for operative activity in medicine and technology, and also to instrument parts. This has the advantage that even individual parts which only yield an instrument when assembled can also be selectively identified and selected from a multiplicity of unsorted parts by means of the present invention. This is particularly useful if specific instruments have to be disassembled for specific purposes, such as cleaning processes, and reassemble is necessary afterwards.

Hereinafter, reference is often made to medical instruments by way of example. In this case, the explanations given in this case should be understood such that, where possible, they are also analogously applicable to corresponding non-medical equipment. The present invention is thus also applicable to technical instruments and tools from the fields of mechanics such as pliers, screwdrivers, open-ended wrenches, natural sciences such as biology or chemistry, materials science, etc.

In a further embodiment of the invention, the at least one weight sensor comprises tactile sensors.

The use of tactile sensors has the advantage that the latter are comparatively thin, can be mounted onto different surfaces and, moreover, require little maintenance. Furthermore, it is possible to adapt the resolution of the weight distribution images or weight distribution data obtained according to the requirements by increasing or decreasing the number of tactile sensors of such a weight sensor per unit area. Thus, depending on the area of application, either the amount of data can be reduced by decreasing the resolution or, alternatively, the resolution can be increased for the purpose of higher accuracy.

In the context of this invention, the term “tactile sensor” should be understood to mean firstly the tactile sensors that are familiar to the person skilled in the art and are also commercially available, and also generally any type of force or pressure distribution sensors which are suitable for the use according to the invention.

In a further embodiment of the invention, the data processing system is designed such that it can represent the received weight distribution data and the result of the identification on the visualization unit.

This embodiment makes it possible that the data processing system, after the identification of the individual instruments that were placed onto the weight sensor alongside one another, can indicate, on the visualization unit, which instruments are involved, at which location they lie on the weight sensor, and if appropriate—for producing instrument sets—which of the instruments should be taken or used. In addition, it is possible that the corresponding weight distribution data can be displayed in graphical form as weight distribution images on the visualization unit. The visualization unit can preferably be a commercially available standard monitor. However, it is also conceivable for display or visualization units produced especially for the device to be used, which, for example, only display information about the type of instruments lying there and/or their number.

In a further embodiment of the present invention, the device further comprises at least one placement unit for adding or removing instruments to or from the at least one weight sensor, and the data processing system further comprises a control unit for controlling the at least one placement unit.

The provision of such a placement unit has the advantage that both automatic loading of the at least one weight sensor and automatic removal of specific instruments from the weight sensor thus become possible. This forms the basis for the device making it possible to automatically assemble a corresponding instrument set in collecting containers provided for this purpose. One such example is assembling a medical instrument set in an instrument tray for the purpose of sterilization and use in an operation. For this purpose, the placement unit is directly connected to the data processing system via a control unit and thus receives precise information about which instrument is situated at which location on the weight sensor. Together with lists of items for corresponding instrument sets that can additionally be stored in the data processing system, a respective user can thus have the desired set assembled by the device according to the present invention directly by choosing a specific type of set.

In one preferred embodiment of the present invention, the at least one placement unit comprises a robot.

The use of a robot has the advantage that the latter can take off exactly the desired instruments from the area of the weight sensor, even if said instruments are arranged in a manner distributed in a jumble on said sensor. This takes place, for example, by virtue of the fact that said robot can access the weight sensor from above. In this context, robot shall preferably mean a machine that is capable of moving parts, especially individual instruments in the present case, in at least one, preferably two, and even more preferred three dimensions upon control by another device, like the data processing system or its control unit, for example.

The object of the present invention is also achieved by a method for detecting a weight distribution of at least one individual instrument with a device of the type described above, which method comprises the following steps:
a) placing the at least one individual instrument onto the at least one weight sensor,
b) determining the weight distribution of the at least one individual instrument by means of the at least one weight sensor, thus providing weight distribution data,
c) forwarding the weight distribution data determined to the data processing system, and
e) storing the weight distribution data in the database.

Carrying out this method advantageously provides the possibility of an identification of instruments on the basis of their weight distribution data or weight distribution images by firstly references or reference images being stored in the system of the data processing system, here in the database. The processing unit can have access to these reference images later for a comparison with newly placed instruments to be identified.

In a further embodiment of the method for detecting a weight distribution of at least one individual instrument, this method further comprises the following step between steps c) an e):
d) displaying the weight distribution data determined in graphical form on the visualization unit.

Displaying the data on the visualization unit has the advantage of allowing a user who creates or would like to create the reference data of the respective instruments to directly view and, if appropriate, supervise an image of the detected data, that is to say the weight distribution image, during the detection process.

In a further embodiment of the method for detecting a weight distribution of at least one individual instrument, this method further comprises the following step:
f) entering and storing the designation of the instrument placed.

This step of the method has the advantage that, during a later identification, not only is it possible for example for an image to be displayed on the visualization unit, by means of which image a user may recognize the kind of instrument, but the exact name of the instrument is also displayed. In this respect, as an alternative or in addition it can also be provided that further indications such as, for example, size or other dimensions, registration date, cleaning cycles or the like can also be entered and stored and thus displayed later. The attachment of an image to the data set, which can be obtained by another data source, is also conceivable as an alternative or in addition.

In a further embodiment of the method for detecting a weight distribution of at least one individual instrument, the weight distribution data comprises a centroid, and the method further comprises the following steps:
g) calculating the centroid of the weight distribution data, and
h) storing the calculated centroid of the weight distribution data.

Determining and storing the centroid of the weight distribution data or of the weight distribution image has the advantage that said centroid is suitable as a reference point for a later comparison. The reason for this is that the centroid calculated from the weight distribution image of an instrument type is likewise characteristic of each individual instrument type. Consequently, addition of the centroid to the corresponding data set of the weight distribution simplifies a later identification of an instrument. Furthermore, it accelerates the comparison process if such a centroid does not have to be calculated anew each time, rather access can be had to stored data.

Furthermore, the object of the present invention is also achieved by a method for identifying individual instruments with a device of the type described above, which method comprises the following steps:
a) placing at least one individual instrument onto the at least one weight sensor,
b) determining the weight distribution of the at least one individual instrument by means of the at least one weight sensor, thus providing weight distribution data,
c) forwarding the weight distribution data determined to the data processing system,
d) comparing the weight distribution data of the at least one individual instrument with already stored weight distribution data of instruments and determining the respective similarity, and
e) identifying the at least one instrument on the basis of the greatest similarity between the weight distribution data determined and the stored weight distribution data.

The identification of an individual instrument in this way has the advantage that it is not necessary for identification data of the instrument to be read in separately, and it suffices merely for the instrument to be placed onto the weight sensor via a user. Furthermore, this method also allows the identification of a plurality of individual instruments simultaneously, as has already been explained before, which leads to a high efficiency of this identification method. By comparison with the '014 patent mentioned above and the methods disclosed therein, therefore, producing instrument sets does not necessitate placing the instruments successively in a time-consuming manner. For use in an operating theatre in the form of an instrument table, as described in the further device in the '014 patent, this method furthermore has the advantage that inaccuracies as a result of the separation into different zones for different instruments and the identification—necessary in that context—of the removing or placing hand of a surgeon or of an auxiliary person cannot occur. In the present method, the addition or removal of a medical instrument would be registered by the change in weight at the corresponding location and an identification would be effected on the basis of the instrument-specific weight distribution. It would thus be irrelevant from where a corresponding instrument is removed or where a corresponding instrument is put down.

In a further embodiment of the method for identifying individual instruments, this method further comprises the following step:
f) indicating the identified at least one individual instrument on the visualization unit.

This has the advantage, in accordance with the explanations given above, that a corresponding user can immediately get the information which instrument was placed onto the corresponding weight sensor or taken off the latter. For the application in connection with the assembly of an instrument set, it is furthermore thus possible to display to the user where on the weight sensor which instrument is situated and how the latter is designated. Furthermore, the data processing system can also be designed such that it additionally displays to the user the appearance of said instrument by means of the visualization unit. The indication of further data such as, for example, size, weight, cleaning cycles or registration date and the like is also conceivable. With regard to the application in an operating theatre, further provision could be made for displaying to the user which instruments are currently in use, that is to say have been taken off the weight sensor, by means of the visualization unit.

In a further embodiment of the method for identifying individual instruments, the weight distribution data comprises a centroid, and the method further comprises in comparison step d) the following steps:
aa) calculating the centroid of the weight distribution data determined,
bb) superimposing the weight distribution data with already stored weight distribution data of instruments with the respective centroids as common reference point,
cc) rotating the weight distribution data with respect to one another about the centroids in a stepwise manner and determining the respective similarity in each step,
dd) determining the maximum similarity from the individual determined similarities of the steps,
ee) repeating steps bb) to dd) for further stored weight distribution data of other instruments, and
ff) determining the greatest maximum similarity among the maximum similarities.

The use of these method steps for comparing the weight distribution data determined with already stored weight distribution data has the advantage that the comparison and, consequently, the method for identifying the individual instruments becomes translationally and rotationally invariant. This means that, for successful identification and recognition of an instrument, the latter does not always have to lie on the same location and with the same orientation on the weight sensor. For this purpose, the centroids of the two weight distribution data or weight distribution images to be compared with one another are calculated. In this case, the situation is preferably such that the centroid of the reference, that is to say of the weight distribution image already stored, has already been calculated and also stored. Consequently, it can be accessed directly.

The centroid respectively calculated in this way is then used in a next step for superimposing the weight distribution images such that the centroids lie one above another, that is to say represent a common reference point. The weight distribution data or weight distribution images are then rotated with respect to one another about their centroids, which takes place in a stepwise manner. In this case, the rotation can be effected such that either one of the two or both weight distribution images simultaneously is or are rotated relative to one another. Here, in a stepwise manner preferably means in identical defined angular segments. This can be, for example, steps of 1 degree in each case. After each rotation step, the respective similarity of the weight distribution images to one another is determined. This can be done by any mathematical methods suitable for this purpose, which then correspondingly yield the similarity in the form of a numerical value as the result. For each comparison of the determined weight distribution image with a stored weight distribution image, the maximum similarity is determined among the determined similarities of the steps after complete rotation. After the weight distribution image determined has been compared with all stored weight distribution images, if appropriate only with the weight distribution images provided for the comparison, the greatest maximum similarity is determined among the maximum similarities respectively determined for the single comparisons mentioned before. Since the greatest maximum similarity results upon the comparison with the reference image of the instrument of the same type, the instrument is thus identified. In this context, greatest similarity, as mentioned before, and greatest maximum similarity are used synonym.

Furthermore, the object of the present invention is also achieved by a method for assembling instrument sets with a device of the type described above, which method comprises the following steps:
a) placing individual instruments onto the at least one weight sensor,
b) identifying the placed individual instruments by means of the data processing system on the basis of the instrument-related weight distribution data determined, and
c) assembling the respective instrument sets based on of the predetermined content of the respective instrument set and the identified individual instruments.

This method has the advantage that, with the aid of identification supported by the data processing system, it is possible to choose relatively rapidly the individual instruments, which belong to a corresponding instrument set, from a multiplicity of different instruments. In this case, the method also makes it possible, in particular, that instruments which are very similar at first glance for a corresponding user can be distinguished and selected very rapidly. This can be done for example with the aid of the device described above. Simply placing the entire instruments on the weight sensor makes it possible to identify the instruments by means of the data processing system on the basis of the data of the weight sensor. For this purpose, the instruments should preferably be placed onto the weight sensor side by side. The data processing system then identifies the placed instruments and displays to the user, if appropriate, with the aid of the visualization unit, the instruments required for a preselected instrument set. This can also be done, as necessary, with the aid of a visual representation of the weight sensor and indication of the respective position of the instrument to be taken.

In a further embodiment of the method for assembling instrument sets, this method proceeds in identification step b) according to a method for identifying individual instruments of the type described above.

The use of this method for identifying instruments of the type described above adds the advantages described in that context to this method for assembling instrument sets.

In a further embodiment of the method for assembling instrument sets, this method comprises, in step c) of assembling the respective instrument sets, the following steps:
aa) selecting an individual instrument from the instrument set,
bb) determining the position of the individual instrument on the at least one weight sensor,
cc) controlling the placement unit by means of the control unit, and
dd) transferring the individual instrument from the at least one weight sensor into a collecting container for the instrument set by means of the placement unit.

This embodiment of the method has the advantage that the provision of a corresponding instrument set can thus take place automatically in particular through the use of the placement unit described above. In this case, the preferred embodiment of this method should be understood such that an individual instrument is selected from the instrument set by means of the data processing system. This can be done, for example, via a list—correspondingly stored in the data processing system—of all the associated instruments in relation to the respective instrument set. On the basis of the position data determined by the weight sensor, the placement unit, as a result of controlling by means of the control unit of the data processing system, can then take an individual instrument from the placed instruments and transfer it into a separate collecting container for the respective instrument set. Consequently, this method provides that a respective user merely places the cleaned instruments onto the weight sensor and subsequently selects which instrument sets are intended to be assembled with these instruments. The placement is thereupon effected fully automatically. Furthermore, in the context of the present invention it is also conceivable for the placing of the instruments onto the weight sensor likewise to take place in an automated manner.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

The invention is described and explained in more detail below with reference to a few selected exemplary embodiments in association with the accompanying drawings, in which:

FIG. 1 shows a schematic plan view of a device according to the present invention comprising weight sensor, data processing system and visualization unit,

FIG. 2 shows a schematic perspective illustration of a device according to the invention corresponding to FIG. 1 with an additional robot and collecting container,

FIG. 3 shows a schematic plan view of medical scissors on a weight sensor,

FIG. 4 shows a weight distribution image of the medical scissors from FIG. 3 in a plan view,

FIG. 5 shows a schematic illustration of a weight distribution image of the medical scissors from FIG. 3 in a perspective illustration,

FIG. 6 shows a schematic illustration of the relationship between medical scissors on a weight sensor and the weight distribution image resulting therefrom,

FIG. 7 shows an illustration corresponding to FIG. 6, except with rotated medical scissors,

FIG. 8 shows an illustration corresponding to FIG. 6, except with medical scissors having a curved end,

FIG. 9 shows an illustration corresponding to FIG. 8, wherein the medical scissors now lie with the original top side thereof corresponding to the illustration from FIG. 8 on the weight sensor,

FIG. 10 shows a schematic illustration of the assignment of different medical instruments on a weight sensor to different collecting containers, and

FIGS. 11 to 13 show the collecting containers from FIG. 10 with the medical instruments from FIG. 10 now arranged and sorted therein.

### DETAILED DESCRIPTION OF PREFERRED EMBODIMENTS

A device illustrated in the figures is designated hereinafter in its entirety by the reference numerals 10 and 12, respectively.

As already explained above, the present invention in the form of the device and the method relates to instruments in general. These are e.g. technical instruments and tools from the fields of medicine, mechanics, as known from automobile or aircraft manufacture, natural science, e.g. chemistry, biochemistry, biology or physics, etc., which are used as a tool in the respective fields. In this case, the exemplary explanation given hereinbefore, and in particular hereinafter, on the basis of medical instruments as a preferred exemplary embodiment is not intended to restrict the scope of the invention as such.

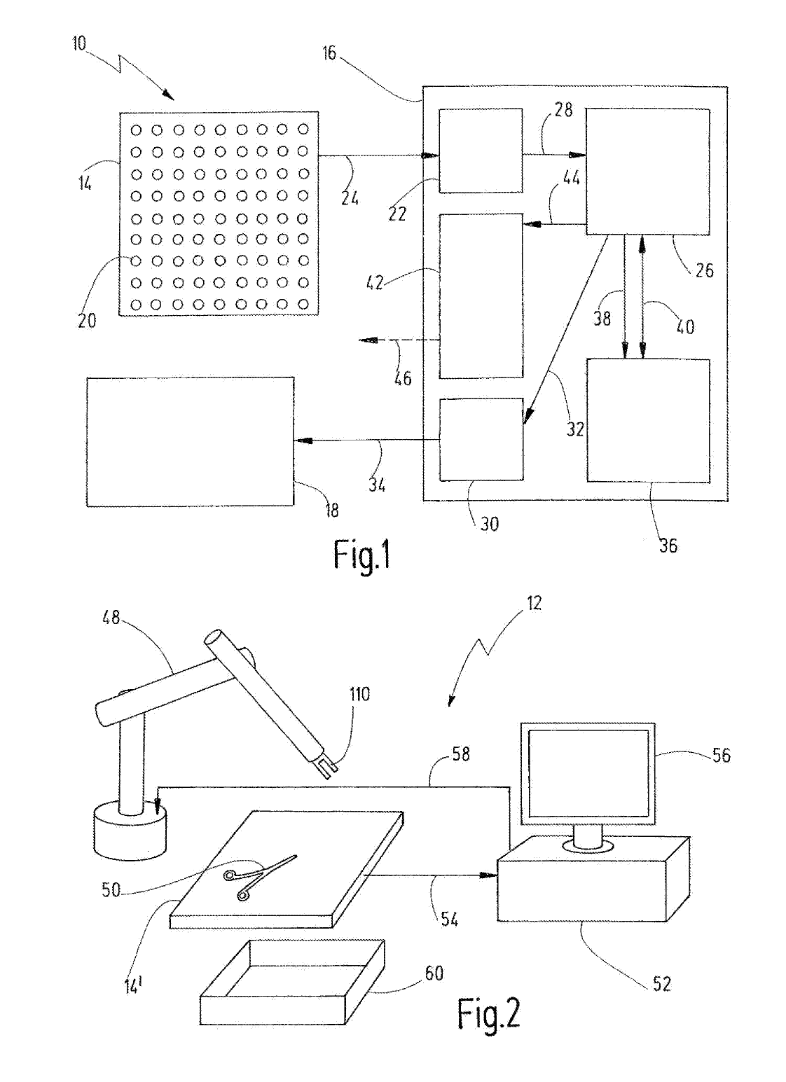

The device 10 illustrated in FIG. 1 comprises a weight sensor 14, a data processing system 16 and a visualization unit 18. The weight sensor 14 illustrated in this exemplary embodiment comprises, for its part, tactile sensors 20. Of these tactile sensors 20, a total of nine by nine are illustrated in a matrix- or array-like arrangement in the present simplified illustration. In commercially available weight sensors 14 of this type, the tactile sensors 20 arranged thereon can have, depending on the desired resolution, densities of approximately 2 sensors/cm² up to high-resolution weight sensors having a density of 144 sensors/cm².

The functioning of said tactile sensors 20 is such that they recognize the force or pressure that is exerted on them and arises as a result of the weight of a medical instrument placed onto the weight sensor 14, which instrument is shown in more detail below, and convert it into different electrical signals depending on the intensity. For this purpose, said tactile sensors 20 are arranged on a support (not shown in more specific detail here) and thus form together with the latter the weight sensor 14 mentioned above. For this purpose, the tactile sensors 20 can be present in a type of film which, in principle, thus allows such a weight sensor 14 to be produced on any desired supports. Said supports can be, for example, tables, trays, boxes or the like.

The information in the form of the abovementioned electrical signals obtained by the tactile sensors 20 of the weight sensor 14 is forwarded to an interface 22 of the data processing system 16, as is indicated schematically by the arrow 24. From said interface 22, the data are forwarded within the data processing system 16 to an processing unit 26. This is indicated schematically by the arrow 28.

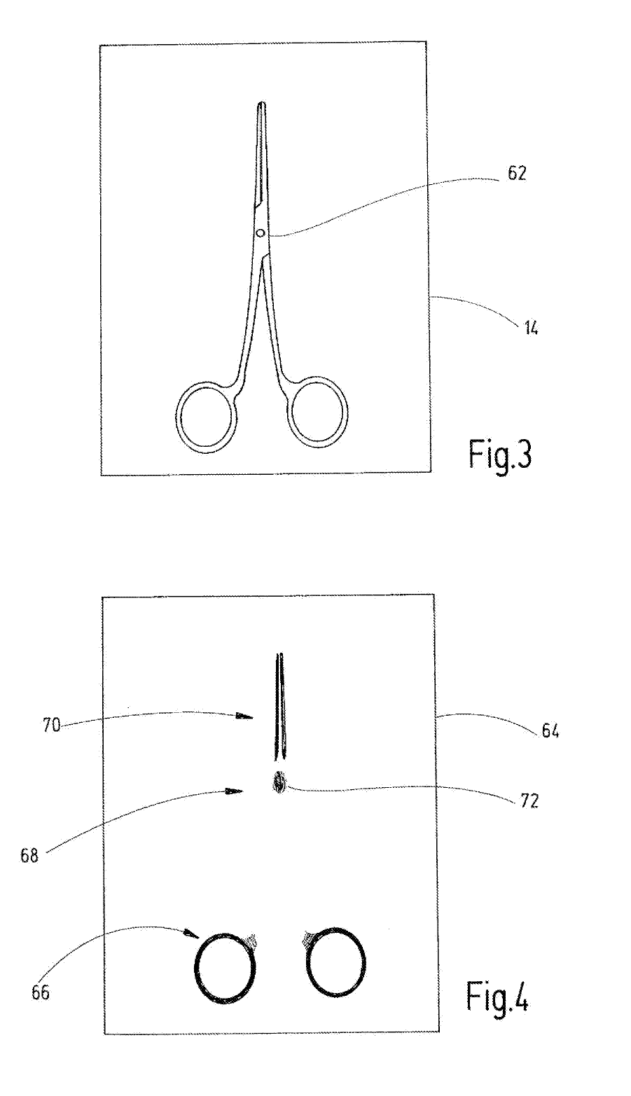

The corresponding data are either processed or conditioned in said processing unit 26. Thus, there is firstly the possibility that the data then conditioned can be forwarded via a further interface 30 to the visualization unit 18. This is illustrated schematically by the arrows 32 and 34. Since the tactile sensors 20, depending on the weight currently burdening them, provide a signal characteristic thereof, it is possible to determine the respective local weight of the instrument placed onto the weight sensor 14 at a respective location of a tactile sensor 20 in a differentiated way. As a whole this has the effect that it is thus possible to determine a weight distribution of the medical instrument on the weight sensor 14. How such a weight distribution is manifested will be described in more detail below in association with FIG. 3 et seq.

The form of the data which can be represented on the visualization unit 18 can concern the weight distribution, for example.

Furthermore, it is possible that the data obtained about the corresponding medical instrument can be stored in a database 36 of the data processing system 16. This is preferably likewise done after the conditioning of the data by the processing unit 26, which is indicated schematically by the arrow 38.

It is likewise possible that, for the case where a medical instrument is intended to be identified, the data determined by the weight sensor 14 can be compared, in the data processing system 16, with already stored data of other medical instruments. For this purpose, these data are compared, in the processing unit 26, with the weight distribution data stored in the database 36. This data exchange is indicated schematically by the double-headed arrow 40.

The result of this comparison can then be represented by the processing unit 26 for example by way of the route already described above via the interface 30 on the visualization unit 18.

When mention is made of weight distribution image or weight distribution data here, hereinafter or hereinbefore, these terms should be understood in the context of the present invention such that they are generally interchangeable with each other. However, the weight distribution image is used hereinafter rather in association with the visual representation of the weight distribution data. It should thus be understood in a context of a coordinate system.

A further possibility is the controlling of further devices (not shown more specifically here in FIG. 1) on the basis of this data comparison. For this purpose, the processing unit 26 can then forward data or information to a control unit 42. Said control unit 42 can then in turn control a further device (not shown here) on the basis of said data. These two steps are indicated schematically by the arrow 44 and the dashed arrow 46.

One such device not shown in more specific detail in FIG. 1 can be a placement unit, for example. The latter can comprise a robot 48. Such a robot 48 is illustrated in FIG. 2 in association with the embodiment of the device 12 shown therein. In the case of this device 12, a weight sensor 14′ is likewise shown, a schematically illustrated medical instrument, here scissors 50, lying on said weight sensor 14′ in this case. The weight sensor 14′ here forwards data to a computer 52. Said computer 52 substantially represents the data processing system 16 from FIG. 1. The forwarding of the data is indicated by an arrow 54 here analogously to the arrow 24 from FIG. 1. A monitor 56 is connected to the computer 52. Said monitor 56 substantially represents the visualization unit 18 from FIG. 1.

In accordance with the explanations already given in association with FIG. 1, the computer 52 is connected to the robot 48. The computer 52 can therefore control said robot 48. This is indicated by an arrow 58 in FIG. 2 analogously to the dashed arrow 46 in FIG. 1.

The weight distribution data comprising also position information of the scissors 50, which were determined by the weight sensor 14′ are accordingly communicated to the computer 52. In the consequence, the robot 48 can now transfer the scissors 50 into an associated collecting container 60 based on the weight distribution data. For this purpose, the computer 52, on the basis of the position information obtained and the identification of the scissors 50, controls the robot 48 in such a way that the scissors 50 are also placed into the correct collecting container 60. For the sake of simplicity, only one collecting container 60 is illustrated in the present case in the illustration in FIG. 2. As will be explained in more detail later, however, particularly in association with FIG. 10 et seq., a multiplicity of such collecting containers 60 can be kept ready for example during the preparation of instrument sets to be sterilized. Into these collecting containers a multiplicity of instruments to be sterilized are sorted in accordance with specific predetermined requirements and conditions. Said collecting containers 60 are preferably so-called instrument trays in such a case.

FIG. 3 shows scissors 62 arranged in a manner lying on a weight sensor 14. In this simplified illustration the individual sensors, that is to say the tactile sensors 20, for example, are not shown. The data recorded by the weight sensor 14 in FIG. 3, that is to say the weight distribution data or the weight distribution image, are schematically illustrated in FIG. 4 as a weight distribution image 64.

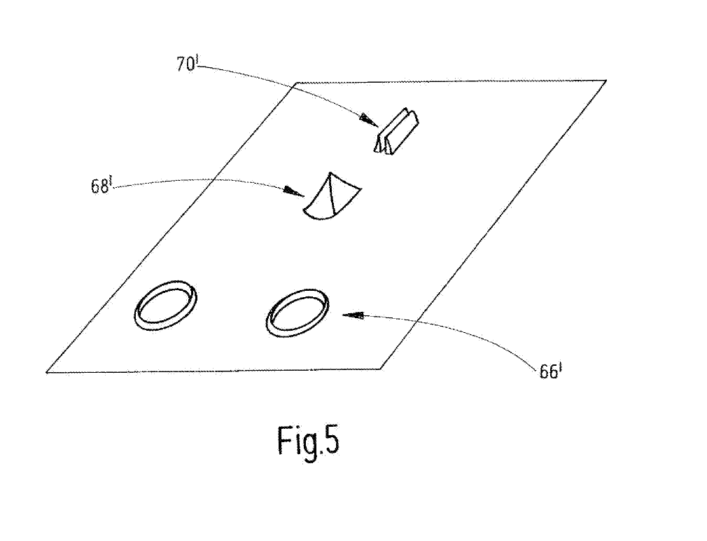

This weight distribution image 64 in FIG. 4 now shows that the scissors 62 from FIG. 3 do not produce weight distribution data at the weight sensor 14 over their entire area. This is owing to the fact, in particular, that the scissors 62 bear directly on the weight sensor 14 only at specific locations. Thus, only indications of the handles, the pivot and the cutting region are seen here, which is illustrated by the arrows 66, 68 and 70. Depending on the weight distribution of the scissors 62 on the weight sensor 14, the pressure registered at the respective locations on the weight sensor 14 as a result of the weight of this scissors 62 also varies. This is schematically illustrated in FIG. 5 for explanation purposes. It is evident here that the pivot, in particular, indicated here by the arrow 68′, forms a higher peak than, for example, the handles or the cutting region, both indicated by the arrows 66′ and 70′.

Both illustrations in FIG. 4 and FIG. 5 are for example also conceivable for the representation of the weight distribution data or of the weight distribution image on a corresponding visualization unit 18, as has already been described above.

It should be noted in this respect that the weight distribution images or weight distribution data illustrated in FIGS. 4 and 5, just like the weight distribution data additionally illustrated hereinafter, were chosen for elucidation purposes and do not necessarily represent realistic weight distribution data of such scissors 62.

If an identification of a medical instrument is now intended to be carried out by the device according to the present invention, then, in accordance with the above-described possibility of storage, it is first necessary to create a corresponding reference image of this type of medical instrument.

For this purpose, the procedure is such that the medical instrument, that is to say the scissors 62, for example, is placed onto the corresponding weight sensor 14. Said weight sensor 14 then determines the weight distribution of the medical instrument placed, that is to say of the scissors 62, for example. The weight distribution data thus obtained are then forwarded to the data processing system 16. This is indicated by the arrow 24 in FIG. 1. The weight distribution data that have reached the data processing system 16 in this way are then stored in the database 36. This is preferably done by the data received via the interface 22 being forwarded to the processing unit 26 in accordance with the indicated arrow 28, said processing unit 26 then forwarding the data into the database 36. This is indicated by the arrow 38.

Prior to storage, it is furthermore also possible for the data to be displayed on the visualization unit 18. This is preferably done in accordance with the illustration in FIG. 1 via the interface 30, as indicated by the arrows 32 and 34. In this case, the representation in graphical form can be effected, for example, in the manner illustrated by the schematically indicated weight distribution data or weight distribution images in FIGS. 4 and 5. Besides outputting of the weight distribution data in graphical form prior to storage of the weight distribution data in the database 36, outputting during or after the storage operation is, of course, also possible and conceivable in the context of this invention.

In addition to simply storing the weight distribution image or the weight distribution data, it is entirely expedient if, in addition, even further data concerning the instrument placed are stored. This can be done, for example, by inputting via an additional input device (not shown more specifically here in the figures). Such an input device can be a commercially available keyboard, for example, which is connected to the data processing system 16. The data additionally input in this way may concern the designation of the instrument as one example. Furthermore, it is also conceivable in this respect for further data to be input, such as, for example, dimensions, date of purchase or registration date, number of cleaning cycles or the like.

Furthermore, in one preferred embodiment of the present devices 10 and 12, it is provided that the latter, in the case of the method currently described here for detecting the weight distribution of the medical instrument, finally perform further processing steps with the weight distribution data determined. One such processing step is, for example, the calculation of the centroid of the weight distribution data or of the weight distribution image. This can likewise be done in the processing unit 26, for example. A centroid determined in this way has the advantage that it represents a uniform reference point for later comparisons of weight distribution data or weight distribution images. For this purpose, it is then necessary for this calculated centroid of the weight distribution data to be stored. This is preferably done in addition and added to the determined weight distribution data set and the possibly additionally input data concerning the placed instrument in the database 36.

For further explanations in association with the scissors 62 presented in FIG. 3, it should be assumed that the calculation of the centroid in the case of the weight distribution image 64 resulting from the scissors 62 is a centroid 72 in the middle of the imaging—indicated by the arrow 68—of the pivot of the scissors 62.

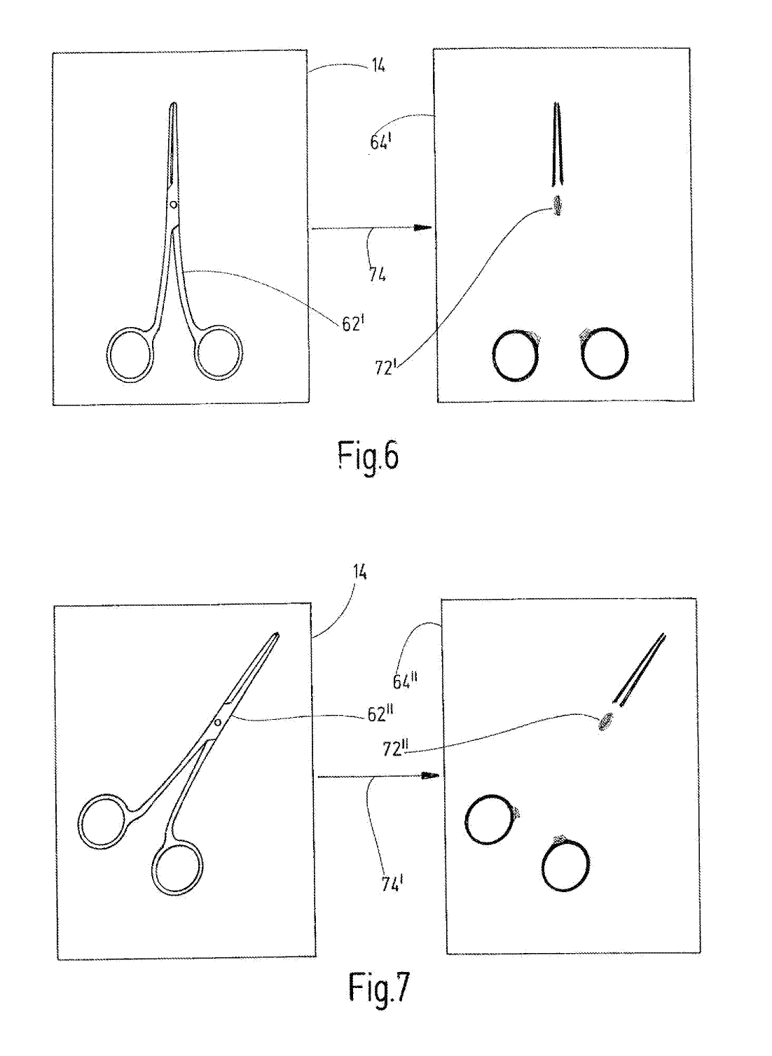

Furthermore, it should be assumed that the weight distribution data 64 determined from the scissors 62 from FIG. 3 serve as stored reference for the description that will now follow in association with FIGS. 6 and 7. Said reference is stored in accordance with the previous explanations in the database 36 of the data processing system 16.

If a further medical instrument 62′ in accordance with the illustration in FIG. 6 is now intended to be identified, then said instrument is firstly also placed onto the weight sensor 14. This then again leads to separate determined weight distribution data or the weight distribution image 64′. This is indicated by the arrow 74. After the determination of this weight distribution in accordance with the weight distribution image 64′ by the weight sensor 14, the weight distribution data thus determined are forwarded to the data processing system 16. The data processing system 16 then carries out a comparison of the now determined weight distribution data 64′ with the weight distribution data previously stored as reference in the database 36. In this case, during each step of comparing currently determined weight distribution data and stored weight distribution data, the similarity between these two data sets is determined. This can be done according to mathematical methods, for example, which will be explained in more detail hereinafter. Out of the determined similarities between the currently determined weight distribution data 64′ and the reference data, the greatest similarity is now determined. On the basis of this greatest similarity, the medical instruments 62′ placed is then correspondingly identified.

For the present fictitious example, the result manifested in this way would be that the weight distribution data 64′ have precisely the greatest similarity to the already stored weight distribution data 64 from FIG. 4. In accordance with the additional data stored in association with these weight distribution data 64, the identification of the medical instrument 62′ then results in the form that the same instrument type as the scissors 62 in FIG. 3 is involved in this case.

This result is then displayed on the visualization unit 18 in one preferred embodiment.

In order to carry out such a comparison, provision is made for the corresponding weight distribution data, that is to say here 64 and 64′, to be superimposed for the purpose of determining the similarity. In order to have a reference point for this purpose, it would be conceivable simply to use identical coordinates of the respective weight distribution images and, with reference thereto, to place the weight distribution images one above another. However, this is disadvantageous to the effect that a medical instrument 62′ placed onto a different position on the weight sensor 14 yields a different weight distribution image 64′ than the medical instrument 62 in the original storage of the weight distribution data 64. This would therefore give rise to the case of translational variance, which is not desirable for a comparison correspondingly described above. In order to eliminate this problem, the present invention proposes calculating the centroid 72 for the determined weight distribution images or weight distribution data and superimposing the latter on the basis of and with reference to said centroid 72. The comparison method becomes translationally invariant as a result.

In the present example in FIG. 6, the centroid 72′ would be able to be calculated. During the comparison of the weight distribution images 64′ and 64, the two centroids 72 and 72′ would then be placed one above another. In this case, a complete congruence of the two weight distribution images 64 and 64′ would result here. This signifies a great similarity.

Besides the problem of translational variance, the problem of rotational variance also exists, in principle, for the comparisons described in the present case. This and the associated solution according to the present invention will be described in association with FIG. 7.

The medical instrument 62″ placed onto the weight sensor 14 in FIG. 7 is recognizably similar to the scissors 62 and 62′ in FIGS. 3 and 6. The difference here in the illustration of FIG. 7, however, is that said medical instrument 62″ has been placed onto the weight sensor 14 in a manner rotated slightly towards the right with reference to the illustration of FIG. 6. A weight distribution image 64″ is again determined from this placed medical instrument 62″, as is indicated by the arrow 74′. After the weight distribution data 64″ determined have been forwarded to the data processing system 16, the latter will compare the determined weight distribution data 64″ with already stored weight distribution data 64 and in the process determine the similarity between these two weight distribution data. This comparison is preferably carried out by the processing unit 26 of the data processing system 16.

The comparison per se firstly comprises, in accordance with the description above, the calculation of the centroid 72″ of the weight distribution image 64″. With exact superimposition of this centroid 72″ with the centroids 72 of the stored weight distribution data, the respective weight distribution images 64 and 64″ are superimposed. The centroids 72″ and 72 thus serve as reference points.

The determination—described hereinbefore and also hereinafter—of the centroid of the weight distribution images or weight distribution data having the coordinates xₛ, yₛ in a two-dimensional coordinate system (not explained in greater detail here) is effected in accordance with formula (1) represented below:

$${x}_{s} = \frac{1}{{\sum }_{x = 1}^{N} {\sum }_{y = 1}^{M} A ( x , y ) \cdot G ( x , y )} \cdot {\sum }_{x = 1}^{N} {\sum }_{y = 1}^{M} x \cdot A ( x , y ) \cdot G ( x , y ) \\ {y}_{s} = \frac{1}{{\sum }_{x = 1}^{N} {\sum }_{y = 1}^{M} A ( x , y ) \cdot G ( x , y )} \cdot {\sum }_{x = 1}^{N} {\sum }_{y = 1}^{M} y \cdot A ( x , y ) \cdot G ( x , y ) \qquad ( 1 )$$

In this case, N and M are the delimitations of the newly determined weight distribution image, and x and y are the respective image coordinates. G denotes the localized weight distribution of the measured weight image, and A represents the matrix for the areal resolution of the sensor cells of the weight sensor 14.

In order now to achieve the superimposition of the weight distribution images 64 and 64″ and thus also to confirm the similarity—evident for this simple example—of the medical instruments 62″ and the scissors 62 on the basis of the method according to the invention, the weight distribution images 64 and 64″ are rotated relative to one another about the centroids 72 and 72″ lying one above another. This can be done by rotating either only the weight distribution image 64, only the weight distribution image 64″ or both weight distribution images 64 and 64″. As one of these three possibilities, the rotation of the weight distribution image 64, that is to say of the stored weight distribution image, will be described hereinafter. This rotation takes place in a stepwise manner. In this context, in a stepwise manner is intended to mean that preferably a rotation by an identical angular range takes place in each step. If, however, on account of different comparison methods, it should be more favourable, rotation of the weight distribution images with respect to one another which is not always uniform would also be conceivable in the context of this invention.

For the present example, however, a uniform rotation of the weight distribution image 64 relative to the weight distribution image 64″ will now be assumed here. The size of such a step, that is to say of an angular range, can be chosen depending on the desired accuracy. However, values in the range of 0.1 to 2 degrees should preferably be chosen here. In particular the choice of an angle of 1 degree for each step appears to be suitable in the present case. In other words, the weight distribution image 64 is rotated about its calculated centroid 72 relative to the weight distribution image 64″ in 360 individual steps.

In each of these steps, the similarity between the respectively rotated reference weight distribution image 64 and the weight distribution image 64″ is determined. The maximum similarity is determined among all the determined similarities of the—in the present case—360 individual steps. In other words, exactly that rotated reference weight distribution image 64 which has the maximum similarity to the determined weight distribution image 64″ is selected as comparison image.

The determination of the maximum similarity can proceed in such a way that a very high value, tending towards infinity, for example, is firstly assumed for a measure of similarity. For each comparison in each step, the similarity is now determined on the basis of the superimposition of the weight distribution image 64″ and the rotated reference weight distribution image 64. This determination of the measure of similarity can take place, for example, according to formula (2) represented below:

$$measure of similarity = {\sum }_{x = 1}^{N} {\sum }_{y = 1}^{M} {( {G}_{reference} ( x , y ) - {G}_{measured} ( x , y ) )}^{2} \qquad ( 2 )$$

In this case, G_{reference} denotes the rotated and displaced weight distribution image 64 of the reference currently used for comparison and G_{measured} denotes the currently measured weight distribution image 64″.

If the similarity between rotated reference weight distribution image 64 and determined weight distribution image 64″ is now greater for one comparison step than in the previous comparisons, which means that the measure of similarity in formula (2) is lower, then this new low measure of similarity is kept. The result is that ultimately the lowest measure of similarity is determined out of all stepwise rotation positions. This represents the maximum similarity between the determined weight distribution image 64″ and the reference weight distribution image 64 in accordance with the explanations given above.

This procedure described above has the effect, in the example shown here in FIGS. 7 and 4, that as a result of rotation of the weight distribution image 64, ultimately an exact superimposition of the two weight distribution images 64 and 64″ in a specific rotation position occurs here, too. The comparison method according to the invention is therefore also rotationally invariant.

In order to carry out a corresponding comparison with all stored weight distribution images, this sequence of steps as described above, that is to say superimposition and rotation, is carried out for the comparison with all weight distribution images stored in the database 36.

If permitted by the storage capacity of the database 36, it would also be conceivable here, for the purpose of reducing the computational complexity for the data processing system 16, to store the reference weight distribution images 64 directly in all possible rotation positions. This can be done preferably at the time of the original detection operation described above in association with FIGS. 3 to 5. In the example described here, this would then be 360 weight distribution images per type of a medical instrument.

The greatest maximum similarity is then determined among the determined maximum similarities of the determined weight distribution image 64″ with the weight distribution images stored or saved in the database 36. On the basis of said greatest maximum similarity the medical instrument 62″ can then be identified, as has already been described above in association with FIG. 6. In the present example, this then likewise again involves a type of instrument identical to the scissors 62.

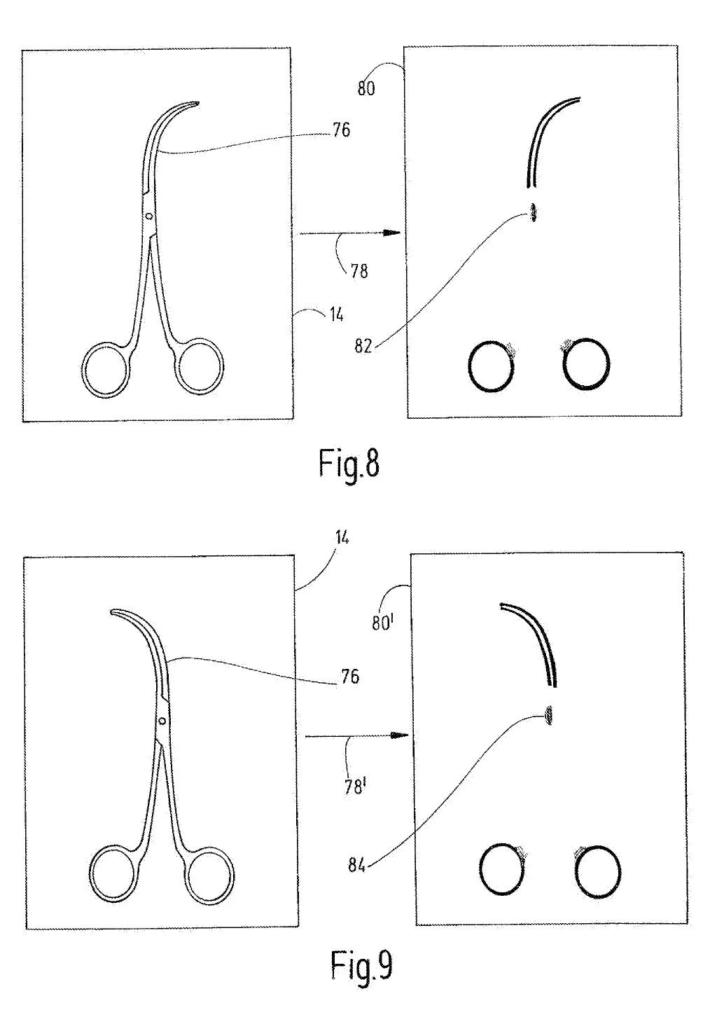

In the above-described case of the scissors 62, which have a perpendicular mirror axis with respect to the illustration in FIG. 3 and in the case of which, therefore, the same weight distribution image 64 always results, irrespective of whether the arrangement is as illustrated in FIG. 3 or whether the top side facing the observer there is arranged on the weight sensor 14. In contrast to this, numerous medical instruments exist whose stable position resting on a surface does not have such a mirror plane of symmetry. One such example is shown and described in association with FIGS. 8 and 9 on the basis of the curved scissors 76 shown therein. As can be seen, the curved scissors 76 in the illustration in FIG. 8 are arranged on the weight sensor 14 such that their cutting end is curved towards the right with respect to the illustration, while in the illustration in FIG. 9 they lie on the weight sensor 14 after having been turned over and the cutting end curves towards the left with respect to the illustration.

These result in weight distribution images 80 and 80′ as demonstrated by arrows 78 and 78′, respectively, which is likewise illustrated in FIGS. 8 and 9. A respective fictitious centroid 82 and 84 of the weight distribution images 80 and 80′ is likewise indicated in FIGS. 8 and 9.

In accordance with the method described above, now during a comparison—assuming the weight distribution image 80 in FIG. 8 was the reference—said image was superimposed with the weight distribution image 80′, such that the centroids 82 and 84 lie one above another. It can readily be discerned here that neither a translation nor a rotation of the weight distribution image 80 relative to the weight distribution image 80′ has the effect that a superimposition with an identity of the weight distribution images 80 and 80′ can be achieved. In other words, the weight distribution image 80 cannot be mapped onto the weight distribution image 80′.

Although the same curved scissors 76 are undoubtedly involved, they yield different weight distribution images 80 and 80′. It is therefore necessary, for the purpose of entirely satisfactory identification of such medical instruments, for each positionally stable state of such a medical instrument on a surface, here the weight sensor 14, to detect a corresponding weight distribution image and to store it as reference in the memory of the data processing system 16, that is to say in the database 36.

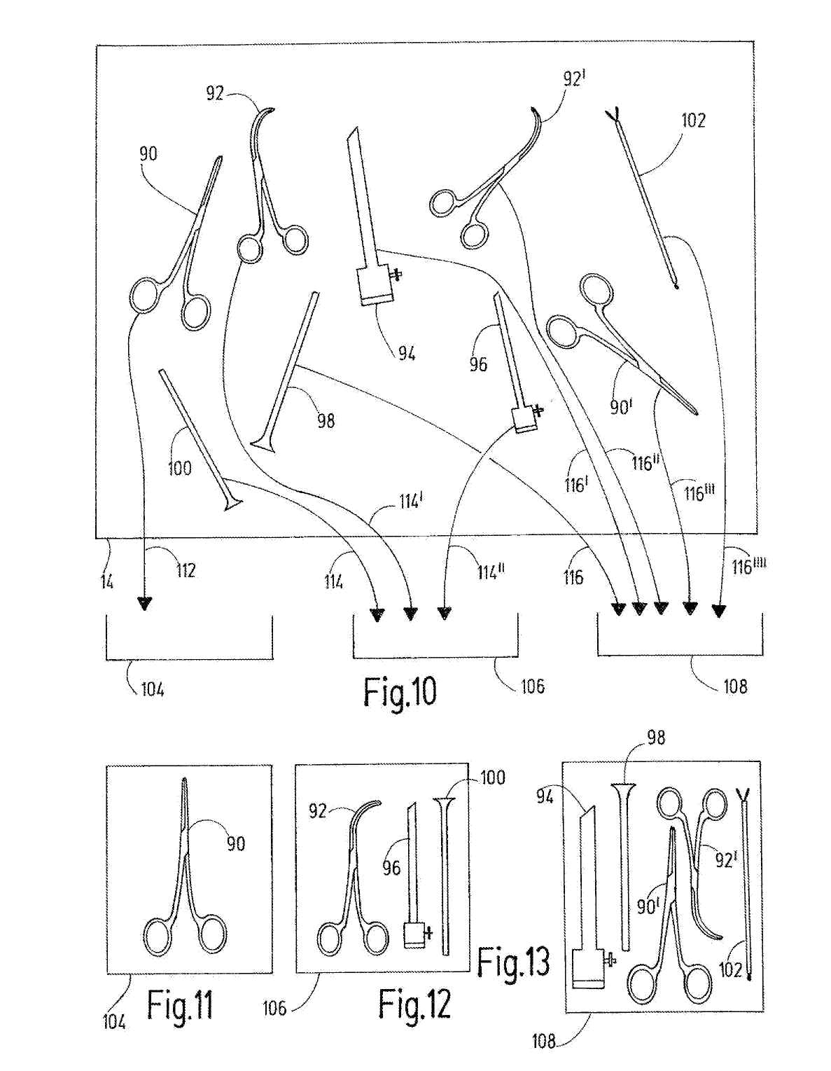

The method for assembling medical instrument sets with an above-described device 10 or 12 will now be explained below with reference to FIGS. 10 to 13.

For this purpose, in a first step, various medical instruments are placed onto a corresponding weight sensor 14. In the case shown in FIG. 10, said instruments are two scissors 90 and 90′, two curved scissors 92 and 92′, one large trocar 94, one trocar 96 that is smaller or has a smaller diameter, one large endoscope 98, one smaller endoscope 100 and a gripping attachment 102 suitable for being used together with the trocars 94 and 96 in a minimally invasive surgical procedure.

These medical instruments are intended to be transferred as different instrument sets into collecting containers provided therefor. Said collecting containers are illustrated schematically in FIG. 10. They are instrument trays 104, 106 and 108. Said instrument trays 104 to 108 are suitable for directly sterilizing the instrument sets thus assembled. For this purpose, they are transferred into an autoclave, for example. The instrument sets thus sterilized can then be transferred with these instrument trays directly into the operating theatre.

For the purpose of enabling simple illustration and elucidation it should be assumed that three simple fictitious instrument sets are involved in this case. Here the first instrument set is intended to consist merely of one pair of scissors for simple intervention. The second instrument set is intended to enable minimally invasive surgical intervention in the case of a child. Whereas the third instrument set is intended to allow minimally invasive surgical intervention and an operation in the case of an adult.

In the method according to the present invention for assembling such a respective instrument set an identification of the medical instruments 90 to 102 is now carried out by the data processing system 16 after the medical instruments 90 to 102 have been placed onto the weight sensor 14 in the manner described above. This is done on the basis of the weight distribution data or weight distribution images, as described comprehensively hereinbefore. This demonstrates another advantage of the described detection of the weight distribution data when compared to other identification methods. This is due to the possibility of simultaneous detection of different medical instruments 90 to 102 by means of the weight distribution data thereof.

For identifying the individual instruments 90 to 102 on the weight sensor 14, in one exemplary embodiment the data processing system 16 simply recognizes the instruments 90 to 102 when they are placed on the weight sensor 14. Since, after all, the instruments are generally placed temporally successively, a detection of individual instruments is possible on the basis of this temporal sequence. The data processing system 16 thus may at least detect them as individual entities. Furthermore, an identification is, of course, also possible immediately.

Besides this embodiment, it is alternatively also possible for the data processing system 16 to go through the overall weight distribution image, comprising the weight distribution data of all the instruments 90 to 102, step by step in the x- and y-direction, and to assume each point thus acquired as a potential centroid. For these respective potential centroids, the above-described rotationally invariant comparison method using the reference weight distribution images stored in the database 36 is then carried out. In this case, among all the comparisons, a maximum of the superimposition results when a weight distribution image corresponds to the reference weight distribution image of a stored individual instrument. After the correspondence, the individual weight distribution image of this identified instrument in the overall weight distribution image can then be set to zero. The data are thus removed from the detected overall weight distribution image for the purpose of simplifying the further comparison sequences. The process of running through the overall image then begins anew until a correspondence is found again. All of the instruments have been identified when the overall weight distribution image present is empty.

After the data processing system 16 has identified the various medical instruments 90 to 102, the assembly of the medical instrument sets now occurs. This is achieved on the basis of conditions given either by means of lists or by means of data likewise stored in the data processing system 16. In this case, it is possible either for a user to pick off the medical instruments 90 to 102 after identification and representation of the identifications on the visualization unit 18 from the weight sensor 14 and to sort them into the instrument trays 104 to 108 provided therefor. Furthermore, it is possible for the visualization unit 18 to output an image, at least in schematic form, of the weight sensor 14 or of the weight sensor surface on the visualization unit 18. In this case, by way of example, the position of a respective medical instrument could then be represented directly on the visualization unit 18. Furthermore, it would also be possible for a respective instrument set that is to be assembled or the type of such an instrument set to be selected by means of the data processing system 16. The data processing system 16 thereupon independently marks on the visualization unit 18 the represented instruments on the weight sensor 14, for example by means of a coloured backing.

Furthermore, it is also conceivable for the entire placement operation to proceed completely automatically, as would be possible for example by means of the device 12 of the type described before. For this purpose, a placement unit, e.g. the robot 48, would then grasp the respective medical instruments and sort them into the instrument trays 104 to 108 provided therefor. For this purpose, the robot 48 likewise receives accurate position data from the data processing system 16, which result on the basis of the entire weight distribution image determined by the weight sensor 14. In this case, the above-described determination of the centroid of the localized, that is to say individual, weight distribution images furthermore affords the advantage that the robot 48 now has the opportunity to grasp a corresponding instrument precisely at said centroid 72, 82 or 84. This has the effect of reducing the risks of the instrument slipping away from or slipping off a gripper 110 of the robot 48.

Independently of whether the instruments shown are now sorted manually or automatically, in the present example the scissors 90 are now transferred into the instrument tray 104, as is illustrated by arrow 112. The small trocar 96, the small endoscope 100 and also the curved scissors 92 are transferred into the instrument tray 106. This is illustrated by arrows 114, 114′ and 114″. Furthermore, the large trocar 94, the large endoscope 98, the curved scissors 92′, the scissors 90′ and the gripper attachment 102 are transferred into the instrument tray 108. This is illustrated by arrows 116, 116′, 116″, 116′″ and 116″″.

The result is the loaded instrument trays 104 to 108, as are illustrated in FIGS. 11 to 13. As already described above, this process can proceed fully automatically by virtue of the data processing system 16 controlling a corresponding placement unit, like the robot 48, via the control unit 42. Said placement unit, e.g. robot 48, thus transfers the instruments from the weight sensor 14 into a respective collecting container, here the instrument trays 104, 108, to form the respective instrument set.

Besides the embodiment described where instruments are assembled to form instrument sets, it is also conceivable, of course, for the proposed method according to the invention to be suitable for automatically sorting instruments, which are discharged from a washer machine, for example, onto said weight sensor, into storage containers provided therefor.

Besides the embodiment shown here in particular in association with FIGS. 2 and 10, wherein the collecting containers 60, 104, 106 and 108 are illustrated as stationary, it is also conceivable for such containers to be transported along the placement unit or the weight sensor 14 on a type of assembly line or conveyor belt. This ultimately makes it possible to provide devices which run completely in an automated fashion. In this case, it is furthermore conceivable that the instrument sets produced and assembled in this way can be transferred directly in an automated fashion into an autoclave for sterilization.

Besides the possibilities shown above in respect of different stable positional states on a surface in association with FIGS. 8 and 9, it should also be pointed out that especially medical instruments having round geometries, such as the trocars 94 and 96, for example, need not have discrete positional states. Hence, a respectively different weight distribution image results here depending on the positioning of the valve of such a trocar 94, 96, said valve being situated at the side and not being designated more specifically here. This can lead to problems during comparison with the stored weight distribution data and thus during identification. In order to eliminate this problem a fixedly predetermined manner of placing the corresponding instruments onto the weight sensor 14 would be possible. Aside from that, it would also be conceivable for a certain greater tolerance to be allowed in the comparison methods for such cases or such medical instruments in the data processing system 16. This can be effected, for example, by virtue of the fact that a special parameter is stored in the database 36 for this purpose. This parameter then makes it possible, in the comparison step, to permit a greater tolerance when determining the similarity during the comparison with such a problematic medical instrument. In addition, the accuracy for the comparison with all the remaining medical instruments can remain unaffectedly high.

As an alternative thereto, it would also be conceivable to combine the methods according to the present invention described and the devices 10, 12 with other methods and devices which are suitable for the identification of medical instruments at least as support.

What is claimed is:

1. A device for identifying individual instruments comprising:
at least one weight sensor, being suitable for determining weight distributions of individual instruments,
a visualization unit, and
a data processing system having an interface, at least one database and a processing unit,
said data processing system being designed such that it can
receive weight distribution data of at least one individual instrument from said at least one weight sensor via said interface,
store said received weight distribution data in said database,
compare said received and/or stored weight distribution data with already stored weight distribution data of instruments, and
thereby identify said at least one individual instrument.

2. The device of claim 1, wherein said at least one weight sensor comprises tactile sensors.

3. The device of claim 1, wherein said data processing system is designed such that it can represent said received weight distribution data and a result of said identification on said visualization unit.

4. The device of claim 1, further comprising:
at least one placement unit for adding or removing instruments to or from said at least one weight sensor, and
wherein said data processing system further comprises a control unit for controlling said at least one placement unit.

5. The device of claim 4, wherein said at least one placement unit comprises a robot.

6. A method for detecting a weight distribution of at least one individual instrument with a device comprising:
at least one weight sensor, being suitable for determining weight distributions of individual instruments,
a visualization unit, and
a data processing system having an interface, at least one database and a processing unit,
which method comprises the following steps:
a) placing at least one individual instrument onto said at least one weight sensor,
b) determining a weight distribution of said at least one individual instrument by means of said at least one weight sensor, thus providing weight distribution data,
c) forwarding said weight distribution data determined to said data processing system, and
e) storing said weight distribution data in said database.

7. The method of claim 6, further comprising the following step d) between steps c) and e):
d) displaying said weight distribution data determined in graphical form on said visualization unit.

8. The method of claim 6, further comprising the following step:
f) entering and storing a designation of said at least one individual instrument placed.

9. The method of claim 6, further comprising the following steps:
g) calculating a centroid of said weight distribution data, and
h) storing said calculated centroid of said weight distribution data.

10. A method for identifying individual instruments with a device comprising:
at least one weight sensor, being suitable for determining weight distributions of individual instruments,
a visualization unit, and
a data processing system having an interface, at least one database and a processing unit,
which method comprises the following steps:
a) placing at least one individual instrument onto said at least one weight sensor,
b) determining a weight distribution of said at least one individual instrument by means of said at least one weight sensor, thus providing weight distribution data,
c) forwarding said weight distribution data determined to said data processing system,
d) comparing said weight distribution data of said at least one individual instrument with already stored weight distribution data of instruments and determining a respective similarity, and
e) identifying said at least one individual instrument on a basis of a greatest similarity between said weight distribution data determined and said stored weight distribution data.

11. The method of claim 10, further comprising the following step:
f) indicating said identified at least one individual instrument on said visualization unit.

12. The method of claim 10, wherein step d) comprises the following steps:
d₁ calculating a centroid of said weight distribution data determined,
d₂ superimposing said weight distribution data with said already stored weight distribution data of instruments with respective centroids as a common reference point,
d₃ rotating said weight distribution data with respect to one another about said centroids in a stepwise manner and determining a respective similarity in each step,
d₄ determining a maximum similarity from said individual determined similarities of said steps,
d₅ repeating steps d₂ to d₄ for further stored weight distribution data of other instruments, and
d₆ determining a greatest maximum similarity among said maximum similarities.

13. A method for assembling instrument sets with a device comprising:
at least one weight sensor, being suitable for determining weight distributions of individual instruments,
a visualization unit,
at least one placement unit for adding or removing instruments to or from said at least one weight sensor, and
a data processing system having an interface, at least one database, a processing unit, and a control unit for controlling said at least one placement unit,
which method comprises the following steps:
a) placing individual instruments onto said at least one weight sensor,
b) identifying said placed individual instruments by means of said data processing system on a basis of instrument-related weight distribution data determined, and
c) assembling a respective instrument set based on a predetermined content of said respective instrument set and said identified individual instruments.

14. The method of claim 13, wherein step b) comprises
b₁ determining a weight distribution of said at least one individual instrument by means of said at least one weight sensor, thus providing weight distribution data,
b₂ forwarding said weight distribution data determined to said data processing system,
b₃ comparing said weight distribution data of said at least one individual instrument with already stored weight distribution data of instruments and determining a respective similarity, and
b₄ identifying said at least one individual instrument on a basis of a greatest similarity between said weight distribution data determined and said stored weight distribution data.

15. The method of claim 14 comprising the following step:
b₅ indicating said identified at least one individual instrument on said visualization unit.

16. The method of claim 13, wherein step b) comprises the following steps:
ba calculating a centroid of said weight distribution data determined,
bb superimposing said weight distribution data with said already stored weight distribution data of instruments with respective centroids as a common reference point,
bc rotating said weight distribution data with respect to one another about said centroids in a stepwise manner and determining a respective similarity in each step,
bd determining a maximum similarity from said individual determined similarities of said steps,
be repeating steps bb) to bd) for further stored weight distribution data of other instruments, and
bf determining a greatest maximum similarity among said maximum similarities.

17. The method of claim 13, wherein step c) of assembling said respective instrument sets comprises the following steps:
c₁ selecting an individual instrument from an instrument set,
c₂ determining a position of said individual instrument on said at least one weight sensor,
c₃ controlling said placement unit by means of said control unit, and
c₄ transferring said individual instrument from said at least one weight sensor into a collecting container for said instrument set by means of said placement unit.
